(19) United States
(12) Patent Application Publication
(10) Pub. No.: US 2016/0117768 A1
(43) Pub. Date: Apr. 28, 2016

(54) SYSTEMS AND METHODS FOR UNIVERSAL IDENTIFICATION OF CREDIT-RELATED DATA IN MULTIPLE COUNTRY-SPECIFIC DATABASES

(71) Applicant: Trans Union LLC, Chicago, IL (US)

(72) Inventors: Alejandro Reskala, Naperville, IL (US); Susan Baleski, Glendale Heights, IL (US); Stanley Parker, Lake Barrington, IL (US); Peter Douglas Beery, Leander, TX (US)

(21) Appl. No.: 14/921,794

(22) Filed: Oct. 23, 2015

Related U.S. Application Data
(60) Provisional application No. 62/068,111, filed on Oct. 24, 2014.

(51) Int. Cl. G06Q 40/02

(52) U.S. Cl. CPC G06Q 40/025

(57) ABSTRACT

Systems and methods are provided for generating a central database with credit-identifying data associated with individuals who have resided in multiple countries. Credit-related data associated with the individuals may be matched from multiple country-specific databases. The central database may include records that flag the existence of the matching credit-related data in the multiple countries. Universal identifiers for uniquely identifying the individuals can be generated and stored in the central database and/or the country-specific databases. Individuals who have moved to another country may more easily obtain credit by allowing credit grantors to retrieve their credit-related data from their previous country and generate more precise risk analyses. Credit grantors may be assisted in tracking the whereabouts of individuals that have been extended credit.

### CROSS-REFERENCE TO RELATED APPLICATION

This application claims the benefit of U.S. Provisional Patent Application No. 62/068,111, filed Oct. 24, 2014, the contents of which are fully incorporated by reference herein.

### TECHNICAL FIELD

This invention relates to systems and methods for the universal identification of credit-related data records. More particularly, the invention provides systems and methods for generating a central database with credit-identifying data associated with individuals who have resided in multiple countries, matching credit-related data associated with the individuals in multiple country-specific databases, flagging in the central database the existence of matching credit-related data in the countries, and generating universal identifiers for uniquely identifying each of the individuals.

### BACKGROUND OF THE INVENTION

Credit grantors, such as financial institutions, utility companies, and the like, typically base their decisions to grant credit or make loans on the general principle of risk. The credit grantors typically avoid granting credit or loans to high risk individuals, or may grant credit or loans to such individuals at higher interest rates or on other terms less favorable than those typically granted to consumers with low risk. Consumer data, including consumer credit information, is collected and used by credit bureaus, financial institutions, and other entities for assessing creditworthiness and aspects of an individual's financial and credit history.

Individuals may move from one country, such as their native country, to another country for economic, personal, or other reasons. Some individuals migrate and settle in another country permanently. Other individuals move temporarily to another country, such as for work assignments or attending educational institutions. After moving to another country, these individuals may need to obtain credit and/or loans. However, an individual who has moved to another country may have an insufficient credit history in that country, and as a result, credit grantors in that country may not be able to adequately evaluate the individual's risk and the individual may not be able to obtain credit and/or loans. While the credit grantors in a particular country may have a counterpart in the previous country where the individual resided, the credit grantors do not currently have a mechanism to identify and utilize the individual's existing credit history in the previous country.

Furthermore, some individuals may fail to repay debts while residing in one country, then move to another country. After these types of individuals have moved, the credit grantors that granted the credit or made the loans may not have adequate information on the location of these individuals since they no longer reside in the original country. As such, the credit grantors may have difficulty in collecting on those debts because the credit grantors have no means of contacting these individuals. It may also be desirable to track and/or contact individuals to whom credit has been granted for the individual's or public's well-being, such as, for example, if healthcare services were rendered or if product-related issues requiring follow up exist.

Therefore, there is a need for systems and methods that can generate a central database with credit-identifying data associated with individuals who have resided in multiple countries, match credit-related data associated with the individuals in multiple country-specific databases, flag in the central database the existence of matching credit-related data in the countries, and generate universal identifiers for uniquely identifying the individuals, in order to, among other things, enable individuals who have moved to another country to more easily obtain credit by allowing credit grantors to retrieve their credit-related data from their previous country and generate more precise risk analyses of such individuals, and assist credit grantors in tracking the whereabouts of individuals that have been extended credit.

### SUMMARY OF THE INVENTION

The invention is intended to solve the above-noted problems by providing systems and methods for the generation of a central database including credit-identifying data associated with individuals who have resided in multiple countries. The systems and methods are designed to, among other things: (1) create a record associated with an individual in a central database, based on data from a first database having credit-related data associated with an individual in a first country; (2) flag the record in the central database to denote that credit-related data associated with the individual exists in the first country; (3) generate a universal identifier for uniquely identifying the individual; (4) store the universal identifier in the central database and transmit the universal identifier to the first database; (5) determine whether a second database has credit-related data associated with the individual in a second country; and (6) if the second database has such credit-related data in the second country, flag the record in the central database to denote that credit-related data associated with the individual exists in the second country, and transmit the universal identifier to the second database.

In an embodiment, first data may be received from a first database at a processor. The first data may be derived from first credit-related data associated with an individual in a first country. A record associated with the individual may be created in a central database, and the record may include the first data. The record may be flagged in the central database to denote that the first credit-related data associated with the individual exists in the first country. A universal identifier for uniquely identifying the individual may be generated and stored in the record in the central database. The universal identifier may also be transmitted to the first database. It may be determined whether a second database has second credit-related data associated with the individual in a second country. If the second database has second credit-related data, the record in the central database may be flagged to denote that the second credit-related data associated with the individual exists in the second country. The universal identifier may also be transmitted to the second database. Second data may be received from the second database that is derived from second credit-related data associated with the individual in the second country. The second data may be stored in the record in the central database.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a universal identification system including a central database.

FIG. 2 shows exemplary database fields that may be included in a central database and country-specific databases that can be utilized in the universal identification system of FIG. 1.

FIG. 3 is a block diagram of one form of a computer or server of FIG. 1, having a memory element with a computer readable medium for implementing the universal identification system.

FIG. 4 is a flowchart illustrating operations for performing the generation of a central database with credit-identifying data associated with individuals who have resided in multiple countries, using the universal identification system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

It should also be noted that the disclosures made in this specification are in accordance with the principles of the embodiments(s), which are intended to be disclosed or interpreted to their broadest extent under the patent laws of the United States and other countries, and while such disclosure may describe or otherwise cover subject matter that may be regulated by other existing laws or regulations in the United States and other countries, including, without limitation, the Fair Credit Reporting Act (FCRA) or the Equal Credit Opportunity Act (ECOA), nothing in this disclosure is intended to suggest or imply noncompliance with any such law or regulation by the assignee.

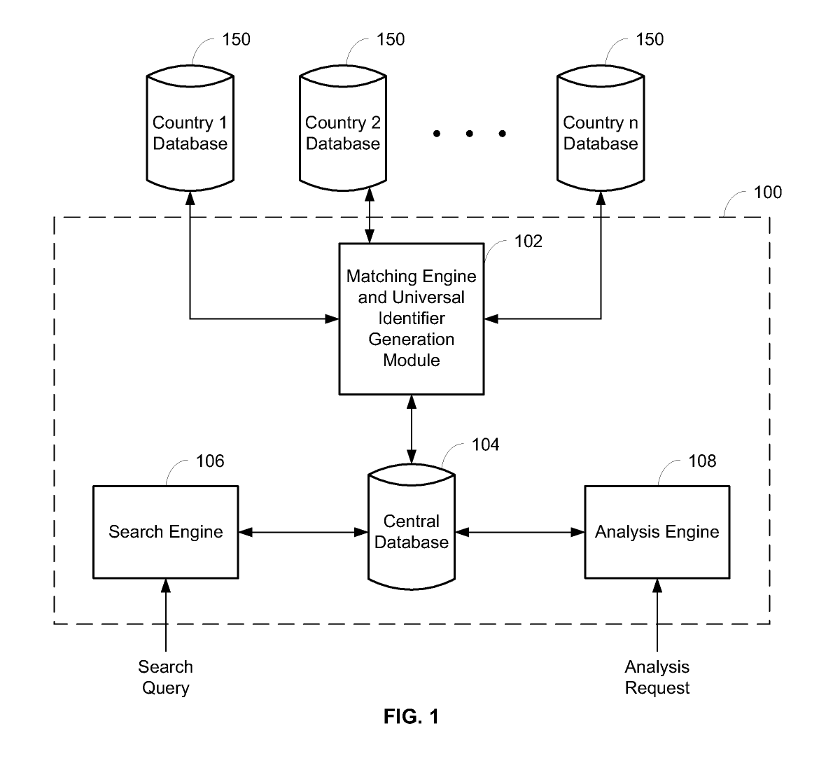

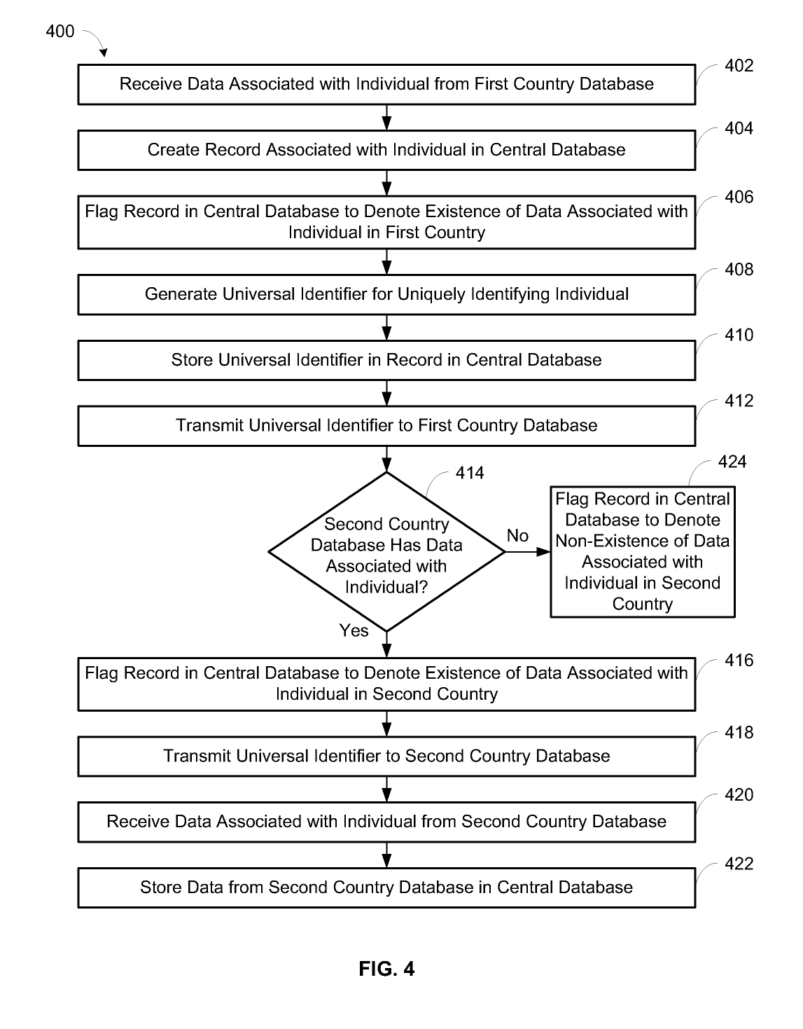

FIG. 1 illustrates a universal identification system 100 for the generation of a central database 104 that includes credit-identifying data associated with individuals who have resided in multiple countries, in accordance with one or more principles of the invention. A process 400 for the generation of the central database 104 that may utilize the universal identification system 100 is shown in FIG. 4. The universal identification system 100 and the process 400 may match credit-related data associated with the individuals in multiple country-specific databases 150 using a matching engine and universal identifier generation module 102. The credit-related data in the country-specific databases 150 may include information associated with the individuals in the respective countries that is related to, for example, credit header data (e.g., name, date of birth, etc.), inquiries, balance changes, tradelines, balances, activations, delinquencies, and payments.

The existence of credit-related data in particular countries can be flagged in the central database 104, and universal identifiers can be generated by the matching engine and universal identifier generation module 102 for uniquely identifying the individuals. The universal identifiers can be stored in the central database 104 and/or transmitted to the country-specific databases 150 for storage locally, as described below.

Once generated, the central database 104 may include information that identifies whether individuals have credit-related data in one or more of the multiple countries corresponding to the databases 150. An individual who has moved to another country may more easily obtain credit because the credit grantors in the individual's new country can utilize the central database 104 to quickly determine the existence of a credit history for the individual in their prior country. The credit grantors could, for example, issue a search query to a search engine 106 or an analysis request to an analysis engine 108 that are in communication with the central database 104. If the existence of a credit history in other countries is found for an individual, then the credit-related data can be retrieved from the other country-specific databases 150, in accordance with applicable laws and regulations. For example, the search engine 106 may retrieve the credit-related data from the country-specific databases 150 in an aggregated mode (i.e., summary mode, if allowed). As another example, the analysis engine 108 may analyze the credit-related data in the country-specific databases 150, such as by calculating a credit score based on retrieved credit-related data, and returning the calculated credit score to the requestor. With this data, the credit grantors can make a more precise risk analysis of the individual in deciding whether to extend credit. Credit grantors may also be able to improve their collections efforts by more easily tracking individuals who have moved to other countries. In some embodiments, the locations and other attributes of individuals may also be utilized for other purposes unrelated to collections efforts.

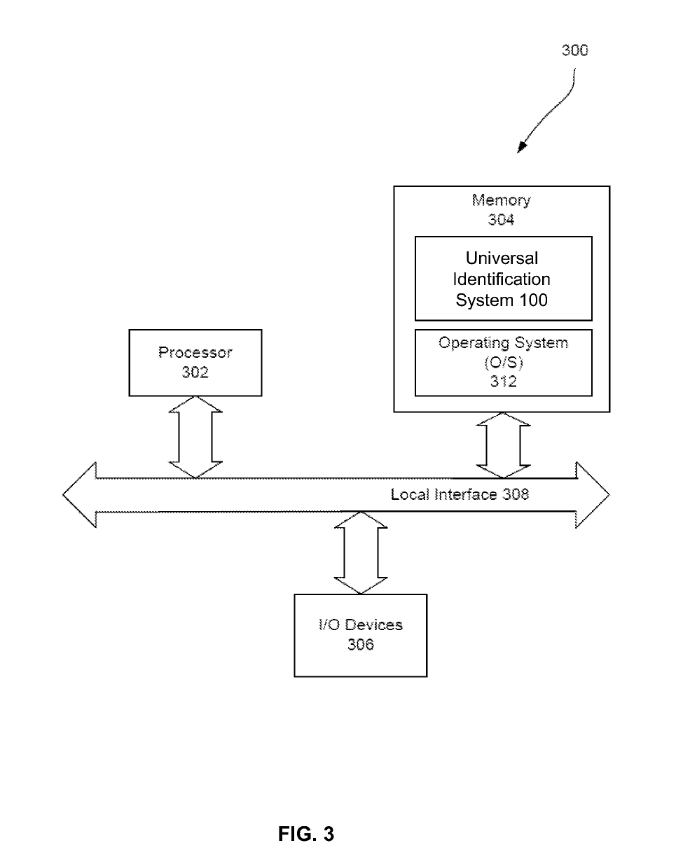

Various components of the universal identification system 100 may be implemented using software executable by one or more servers or computers, such as a computing device 300 with a processor 302 and memory 304 as shown in FIG. 3, which is described in more detail below. The universal identification system 100 may generate the central database 104 in a batch mode (e.g., when initially creating the central database 104 and/or on a periodic basis when updating the central database 104) and/or in real time (e.g., when updating the central database 104). While the systems and methods may be described herein as directed to processing credit-related data for single individuals, it is contemplated that the systems and methods may also be directed to simultaneously or serially processing credit-related data for multiple individuals.

To generate the central database 104, the matching engine and universal identifier generation module 102 may match credit-related data from one of the country-specific databases 150 against credit-related data in another of the country-specific databases 150. Matching may be performed between all possible combinations of the country-specific databases 150. In this way, all of the individuals in all of the country-specific databases 150 may be included in the central database 104. For example, it is possible that there are multiple individuals with the same name in different countries. While these individuals may have the same name, each individual would need to have different universal identifiers assigned to their records in the central database 104, as described below, so that each individual can be uniquely identified.

The matching engine and universal identifier generation module 102 may receive data associated with an individual in a first country, e.g., the United States, from a first country-specific database 150, such as at step 402 of the process 400. The data may be derived from credit-related data associated with the individual in the first country, and may include, for example, a name, a date of birth, and/or a local identifier for uniquely identifying the credit-related data record in the first database 150. The data may be in any suitable format, such as Extensible Markup Language (XML) or other format.

The received data may be used to create a record associated with the individual in the central database 104, such as at step 404. In some embodiments, the received data may be verified against other databases (not shown) to validate its authenticity. Such other databases may include, for example, official databases (e.g., government databases), and/or other reliable public and/or private local data services, such as social networks. In these embodiments, if the received data is determined to not be authentic, then the process 400 may stop. However, if the received data is validated as authentic, then the process 400 may continue.

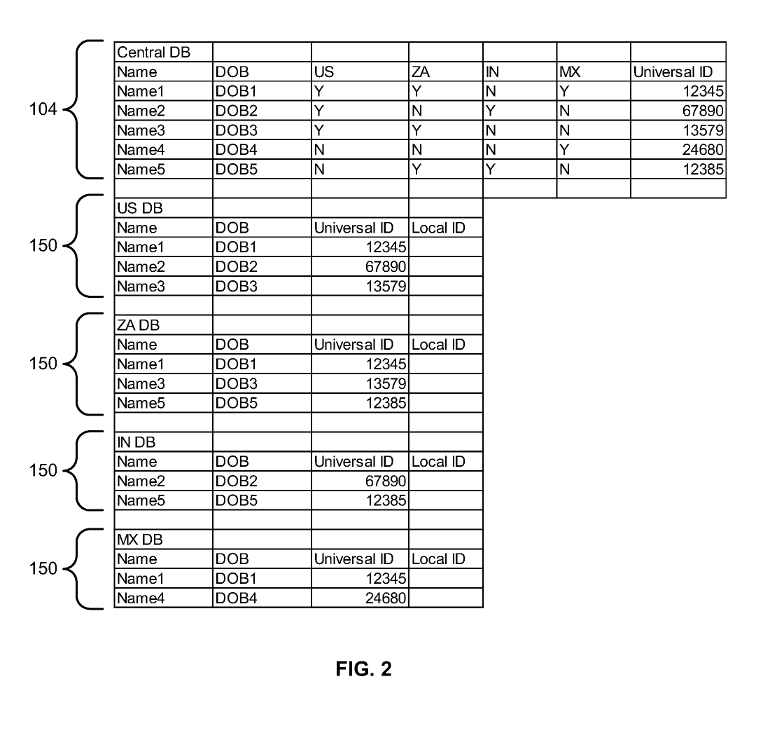

Exemplary fields of the central database 104 and country-specific databases 150 are shown in FIG. 2. The fields shown in FIG. 2 are intended to be non-limiting, and more, less, and/or different fields may be included in the central database 104 and/or country-specific databases 150 without departing from the spirit of the invention. For example, other fields may be included in the central database 104 and/or country-specific databases 150 although not necessarily populated with data, in order to comply with applicable laws and regulations. The record in the central database 104 may include the name and/or date of birth of the individual, for example, as shown by the examples “Name1” and “DOB1”. The field in the central database 104 containing the name is not constrained to any particular format, in order to accommodate variations in the name that may exist in different countries. The local identifier for uniquely identifying the credit-related data record in the first database 150 may also be stored in the central database 104. Other fields included in the central database 104 and country-specific databases 150 may include, for example, a link type that describes the method used to match an individual to records in the country-specific databases 150, and/or a link score that indicates a confidence score for the matches.

At step 406, the record can be flagged in the central database 104 to denote that credit-related data associated with the individual exists in the first country. For example, in FIG. 2 for the individual “Name1”, it is marked under the heading “US” (denoting the United States) that the individual has credit-related data in the first database 150 by the notation “Y”. This notation is exemplary only and any suitable notation to flag the existence of credit-related data may be utilized and is contemplated.

A universal identifier can be generated by the matching engine and universal identifier generation module 102 at step 408. The universal identifier may uniquely identify the individual, and can be stored in the individual's record in the central database 104 (at step 410). The universal identifier may also be transmitted to the first database 150 (at step 412) for storage with the credit-related data record associated with the individual in the first database 150. In FIG. 2, the universal identifier for the individual “Name1” is “12345”. The universal identifiers shown in FIG. 2 are exemplary only and any suitable identification scheme may be utilized and is contemplated.

In some embodiments, the universal identifier may be a randomly generated number, such as a 128-bit random number that is a universally unique identifier (UUID) compliant with the RFC 4122 standard. For example, the universal identifier may be 8fbaafb9-c4d5-40e9-a7b6-11f227e37ec6. The universal identifier may be generated using version 4 of the UUID algorithm. According to the RFC 4122 standard, six bits of the universal identifier are not random and specify the variant and version of the RFC 4122 standard that was used to generate the universal identifier.

After the record has been created in the central database 104, the matching engine and universal identifier generation module 102 can determine at step 414 whether a second country-specific database 150, e.g., for South Africa, has credit-related data associated with the individual in a second country. For example, the name and/or date of birth of the individual that was stored in the central database 104 (based on database 150 for the United States) can be matched to records in the other database 150 (for South Africa) to see if there is any credit-related data for the individual in the second country. Using the name and date of birth can ensure that the individuals with the same name are not erroneously matched to one another since it is unlikely that individuals with the same name would have the same date of birth and have lived in the same countries.

If, at step 414, the second database 150 has credit-related data associated with the individual in the second country, then the matching engine and universal identifier generation module 102 can flag the record at step 416 for the individual in the central database 104 to denote that credit-related data associated with the individual exists in the second country. For example, in FIG. 2 for the individual “Name1”, it is marked under the heading “ZA” (denoting South Africa) that the individual has credit-related data in that particular database 150 by the notation “Y”. The universal identifier that was previously generated may be transmitted at step 418 from the matching engine and universal identifier generation module 102 to the second database 150. The second database 150 may store the universal identifier locally with the credit-related data record associated with the individual.

In some embodiments, data may be received at the matching engine and universal identifier generation module 102 from the second database 150, such as at step 420. The data received at step 420 may be stored in the record associated with the individual in the central database 104 at step 422. Such data may include name variations, a local system-generated identifier, and/or other data. It should be noted that the local system-generated identifier is not the same identifier as government-generated identifiers, e.g., tax identifiers, citizen identifiers, etc.

In other embodiments, one-way hashed or otherwise encrypted data may be received at the matching engine and universal identity generation module 102 from a country-specific database 150. In these embodiments, no clear text name (or other indicative information) would be transmitted out of a country from a country-specific database 150 to the central database 104.

Returning to step 414, if the second database 150 does not have credit-related data associated with the individual in the second country, then the matching engine and universal identifier generation module 102 can flag the record at step 424 for the individual in the central database 104 to denote that credit-related data associated with the individual does not exist in the second country. For example, in FIG. 2 for the individual “Name1”, it is marked under the heading “IN” (denoting India) that the individual does not have credit-related data in that particular database 150 by the notation “N”.

Furthermore, FIG. 2 also shows that the individual “Name1” also has credit-related data in a database 150 for Mexico (denoted by “MX”) as shown by the notation “Y”. Other exemplary individuals “Name2”, “Name3”, “Name4”, and “Name5” are shown in the central database 104 of FIG. 2 as having respective dates of birth and universal identifiers. In addition, the existence or non-existence of credit-related data in particular countries for these other exemplary individuals is also shown in FIG. 2.

As described above, it can be seen that the universal identifier generated by the matching engine and universal identifier generation module 102 may be the only piece of data that is shared among the central database 104 and the country-specific databases 150. The universal identifier acts as a cross-reference between the records of the central database 104 and the credit-related data records in the various country-specific databases 150. The central database 104 and the country-specific databases 150 effectively act as a distributed or federated database. Accordingly, credit grantors in a given country can quickly and easily determine from their local credit bureau provider (e.g., through a country-specific database 150) whether an individual has credit-related data in other countries. The credit grantors can subsequently retrieve and/or analyze the credit-related data (e.g., credit scores) associated with the individual from the other country or countries in making credit decisions. In some embodiments, local credit bureau providers can disclose the universal identifier to individuals, such as through various direct to consumer services of the local credit bureau providers. In turn, individuals can give their universal identifier to a credit grantor so that the credit grantor can quickly request from the credit bureau provider the credit-related data associated with the individual in the countries that individual has resided in.

The matching engine and universal identifier generation module 102 and central database 104 may provide a variety of services to enable credit grantors and local credit bureau providers to query for and/or modify information in the central database 104. A first service includes retrieving the universal identifier for an individual by querying the central database 104 with data associated with the individual, such as name, date of birth, address(es), government-generated identification number(s), phone number(s), and/or employment information. A second service includes adding additional information associated with an individual to the central database 104 by executing a command including the universal identifier and the additional information. A third service includes confirming linkages between multiple records associated with an individual in the central database 104 by executing a command including multiple universal identifiers and a link type. A fourth service includes unlinking multiple previously-linked records associated with an individual in the central database 104 by executing a command including the multiple universal identifiers.

A fifth service includes retrieving data stored in the central database 104 by executing a command including a particular universal identifier. The data returned using this service may be filtered, in accordance with applicable laws and regulations. A sixth service includes calculating a score from the central database 104 that indicates the likelihood that the individual associated with a particular universal identifier is the same individual associated with querying data. This service may be executed using a command including the particular universal identifier and the querying data. A seventh service includes returning a list of individuals that are related to a particular universal identifier by executing a command including the particular universal identifier. The returned list of individuals may include a link type, a link score, and/or filtered data, in accordance with applicable laws and regulations.

When a new individual is added to a country-specific database 150, the data associated with the new individual may be matched against the central database 104. In particular, the matching engine and universal identifier generation module 102 may compare the data associated with the new individual with existing records in the central database 104 to determine whether the new individual matches an individual that already exists in the central database 104. If there is a match, then the matching engine and universal identifier generation module 102 can link the existing record for the individual in the central database 104 to the new individual in the country-specific database 150.

It may also be possible that the central database 104 may include multiple records for the same individual, where the multiple records have different generated universal identifiers. In this case, if the matching engine and universal identifier generation module 102 determines that the multiple records are indeed associated with the same individual, then the data from these multiple records can be merged into one record in the central database 104. One of the universal identifiers may be maintained for the resulting merged record and the other universal identifiers may be deprecated. The country-specific databases 150 may be updated so that they include only the maintained universal identifier.

It may further be possible that the central database 104 includes a single record associated with an individual that is later determined to actually be associated with multiple individuals. The single record may have a single universal identifier. In this case, the matching engine and universal identifier generation module 102 may assign one or more new universal identifiers for the other individuals along with the creation of new records associated with the other individuals. In addition, the existing data in the single record may be allocated to each of the individuals, as appropriate. The country-specific databases 150 may also be updated so that they include the original and new universal identifiers for the correct individuals.

It may also be possible that the local identifiers in the country-specific databases 150 may change. If the local identifiers are changed, the central database 104 may be updated to reflect the new local identifiers. A command may be executed to update the local identifiers in the central database 104 for particular individuals. The command may include the universal identifier, an identifier of the country-specific database 150, the old local identifier, and the new local identifier.

FIG. 3 is a block diagram of a computing device 300 housing executable software used to facilitate the universal identification system 100. One or more instances of the computing device 300 may be utilized to implement any, some, or all of the components in the system 100, including the matching engine and universal identifier generation module 102, search engine 106, and the analysis engine 108. Computing device 300 includes a memory element 304. Memory element 304 may include a computer readable medium for implementing the system 100, and for implementing particular system transactions. Memory element 304 may also be utilized to implement the central database 104 and/or the country-specific databases 150. Computing device 300 also contains executable software, some of which may or may not be unique to the system 100.

In some embodiments, the system 100 is implemented in software, as an executable program, and is executed by one or more special or general purpose digital computer(s), such as a mainframe computer, a commodity server, a personal computer (desktop, laptop or otherwise), personal digital assistant, or other handheld computing device. Therefore, computing device 300 may be representative of any computer in which the system 100 resides or partially resides.

Generally, in terms of hardware architecture as shown in FIG. 3, computing device 300 includes a processor 302, a memory 304, and one or more input and/or output (I/O) devices 306 (or peripherals) that are communicatively coupled via a local interface 308. Local interface 308 may be one or more buses or other wired or wireless connections, as is known in the art. Local interface 308 may have additional elements, which are omitted for simplicity, such as controllers, buffers (caches), drivers, transmitters, and receivers to facilitate external communications with other like or dissimilar computing devices. Further, local interface 308 may include address, control, and/or data connections to enable internal communications among the other computer components.

Processor 302 is a hardware device for executing software, particularly software stored in memory 304. Processor 302 can be any custom made or commercially available processor, such as, for example, a Core series or vPro processor made by Intel Corporation, or a Phenom, Athlon or Sempron processor made by Advanced Micro Devices, Inc. In the case where computing device 300 is a server, the processor may be, for example, a Xeon or Itanium processor from Intel, or an Opteron-series processor from Advanced Micro Devices, Inc. Processor 302 may also represent multiple parallel or distributed processors working in unison.

Memory 304 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 304 can have a distributed architecture where various components are situated remote from one another, but are still accessed by processor 302. These other components may reside on devices located elsewhere on a network or in a cloud arrangement.

The software in memory 304 may include one or more separate programs. The separate programs comprise ordered listings of executable instructions for implementing logical functions. In the example of FIG. 3, the software in memory 304 may include the system 100 in accordance with the invention, and a suitable operating system (O/S) 312. Examples of suitable commercially available operating systems 312 are Windows operating systems available from Microsoft Corporation, Mac OS X available from Apple Computer, Inc., a Unix operating system from AT&T, or a Unix-derivative such as BSD or Linux. The operating system O/S 312 will depend on the type of computing device 300. For example, if the computing device 300 is a PDA or handheld computer, the operating system 312 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 312 essentially controls the execution of other computer programs, such as the system 100, and provides scheduling, input-output control, file and data management, memory management, and communication control and related services.

If computing device 300 is an IBM PC compatible computer or the like, the software in memory 304 may further include a basic input output system (BIOS). The BIOS is a set of essential software routines that initialize and test hardware at startup, start operating system 312, and support the transfer of data among the hardware devices. The BIOS is stored in ROM so that the BIOS can be executed when computing device 300 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the system 100 may also be written in a proprietary language developed to interact with these known languages.

I/O device 306 may include input devices such as a keyboard, a mouse, a scanner, a microphone, a touch screen, a bar code reader, or an infra-red reader. It may also include output devices such as a printer, a video display, an audio speaker or headphone port or a projector. I/O device 306 may also comprise devices that communicate with inputs or outputs, such as a short-range transceiver (RFID, Bluetooth, etc.), a telephonic interface, a cellular communication port, a router, or other types of network communication equipment. I/O device 306 may be internal to computing device 300, or may be external and connected wirelessly or via connection cable, such as through a universal serial bus port.

When computing device 300 is in operation, processor 302 is configured to execute software stored within memory 304, to communicate data to and from memory 304, and to generally control operations of computing device 300 pursuant to the software. The system 100 and operating system 312, in whole or in part, may be read by processor 302, buffered within processor 302, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

For purposes of connecting to other computing devices, computing device 300 is equipped with network communication equipment and circuitry. In a preferred embodiment, the network communication equipment includes a network card such as an Ethernet card, or a wireless connection card. In a preferred network environment, each of the plurality of computing devices 300 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 300 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for generating a central database comprising credit-identifying data associated with an individual who has resided in a first country and a second country, using a processor, the method comprising:
receiving first data from a first database at the processor, wherein the first data is derived from first credit-related data associated with the individual in the first country;
creating a record associated with the individual in the central database, using the processor, the record comprising the first data;
flagging the record in the central database to denote that the first credit-related data associated with the individual exists in the first country, using the processor;
generating a universal identifier for uniquely identifying the individual, using the processor;
storing the universal identifier in the record in the central database, using the processor;
transmitting the universal identifier from the processor to the first database;
determining whether a second database has second credit-related data associated with the individual in the second country, using the processor; and
if the second database has the second credit-related data associated with the individual in the second country:
flagging the record in the central database to denote that the second credit-related data associated with the individual exists in the second country, using the processor;
transmitting the universal identifier from the processor to the second database;
receiving second data from the second database at the processor, wherein the second data is derived from the second credit-related data; and
storing the second data in the record in the central database, using the processor.

2. The method of claim 1, wherein the first data comprises one or more of a name, a date of birth, a one-way hash of information indicative of the individual, or a first country-specific identifier for uniquely identifying a first credit-related data record associated with the individual in the first database.

3. The method of claim 2, wherein the first credit-related data record comprises the first credit-related data associated with the individual in the first country.

4. The method of claim 1, wherein determining whether the second database has the second credit-related data associated with the individual in the second country comprises matching at least a portion of the record in the central database with the second credit-related data in the second database, using the processor.

5. The method of claim 4, wherein matching at least the portion of the record in the central database comprises matching one or more of a name or a date of birth in the central database to the second credit-related data in the second database, using the processor.

6. The method of claim 1 further comprising:
if the second database does not have the second credit-related data associated with the individual in the second country, flagging the record in the central database to denote that the second credit-related data associated with the individual does not exist in the second country, using the processor.

7. The method of claim 1:
further comprising validating authenticity of the first data against a verification database, using the processor;
wherein creating the record comprises creating the record associated with the individual in the central database, using the processor, if the authenticity of the first data is validated.
